(19) United States
(12) Patent Application Publication
(10) Pub. No.: US 2026/0316960 A1
(43) Pub. Date: Oct. 15, 2026

(54) SYSTEMS AND METHODS FOR ANCHORING TO SATELLITES

(71) Applicant: Honeybee Robotics, LLC, Longmont, CO (US)

(72) Inventors: Kris Zacny, Altadena, CA (US); Leo Stolov, Pasadena, CA (US); Gale Leigh Paulsen, Arcadia, CA (US); Dean Bergman, Altadena, CA (US); Kathryn Faye Bywaters, Monrovia, CA (US); Michael Zasadzien, Sylmar, CA (US)

(21) Appl. No.: 19/178,278

(22) Filed: Apr. 14, 2025

(51) Int. Cl. B64G 1/22; B64G 1/64; B64G 1/66

(52) U.S. Cl. CPC B64G 1/1081; B64G 1/66

(57) ABSTRACT

A bolt assembly for use on a spacecraft includes a carrier frame; a bolt body movably accommodated within the carrier frame, the bolt body being movable along a movement axis amongst a neutral position, at least one armed position, and a released position; a bolt head protruding from the bolt body along the movement axis, wherein the bolt head protrudes through the carrier frame when the bolt body is in the released position; and a release mechanism operably coupled with the bolt body, the release mechanism configured to selectively move the bolt body from the at least one armed position to the released position in response to an input signal. The bolt body is capable of piercing a satellite to anchor thereto.

### BACKGROUND

The subject matter disclosed herein relates in general to spacecraft and satellites, and more particularly to satellite interception and anchoring.

In commercial applications, for example some space-debris, satellites or other spacecraft may become inoperable, may pose certain risks, or may require maintenance, adjustment, or de-orbiting. Currently, for satellites and other space-craft that are in orbit around Earth it is common have a planned end of life event. This may be when then, for example, the fuel remaining for maneuvering may fall below a threshold for example. When the end of life event is achieved, the satellite or spacecraft operator may intentionally cause the satellite or de-orbit in a relatively controlled manner. In this way the satellite or space-craft does not create additional debris in orbit.

While existing servicing spacecraft are suitable for their intended purposes the need for improvement remains, particularly in anchoring spacecraft having the features described herein.

### BRIEF DESCRIPTION

According to one aspect of the disclosure, a service satellite is provided. The service satellite may include a main body and a bolt assembly coupled to the main body. The bolt assembly may include a carrier frame; a bolt body movably accommodated within the carrier frame, the bolt body being movable along a movement axis amongst a neutral position, at least one armed position, and a released position; and a bolt head protruding from the bolt body along the movement axis. The bolt head may protrude through the carrier frame when the bolt body is in the released position. The bolt assembly may further include a release mechanism operably coupled with the bolt body. The release mechanism may be configured to selectively move the bolt body from the at least one armed position to the released position in response to an input signal.

According to another aspect of the disclosure, a bolt assembly for use on a spacecraft is provided. The bolt assembly may include a carrier frame and a bolt body movably accommodated within the carrier frame, the bolt body being movable along a movement axis amongst a neutral position, at least one armed position, and a released position. The bolt assembly may further include a bolt head protruding from the bolt body along the movement axis. The bolt head may protrude through the carrier frame when the bolt body is in the released position. The bolt assembly may further include a release mechanism operably coupled with the bolt body. The release mechanism may be configured to selectively move the bolt body from the at least one armed position to the released position in response to an input signal.

According to another aspect of the disclosure, a method of operating a bolt assembly is provided. The method may include receiving an input signal; moving the bolt assembly from a neutral position to at least one armed position in response to receiving the input signal; detecting a proximity to a target object after moving the bolt assembly to the at least one armed position; and releasing the bolt assembly from the armed position in response to detecting the proximity to the target object.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 provides a perspective view of a service satellite according to exemplary embodiments of the present disclosure.

FIG. 2 provides a perspective view of an exemplary shell frame and sensors of the exemplary service satellite of FIG. 1.

FIG. 3 provides a side section view of a bolt assembly according to exemplary embodiments of the present disclosure.

FIG. 4 provides a perspective view of the exemplary bolt assembly of FIG. 3 including a carrier frame and a plurality of rollers.

FIG. 5 provides a perspective cut-away view of the exemplary bolt assembly of FIG. 4.

FIG. 6 provides a flow chart illustrating a method of operating a bolt assembly according to exemplary embodiments of the present disclosure.

### DETAILED DESCRIPTION

Embodiments disclosed herein provide for systems for attaching to target spacecraft or satellites. Moreover, methods of operating servicing satellites, including bolt assemblies, are provided herein.

Embodiments provided herein describe are related to service or servicing satellites. Service satellites typically are deployed to catch, move, disable, or destroy other objects located in orbit, such as space debris, hostile objects, or the like. Such service satellites should be able to move the target in a multitude of direction. Accordingly, an anchoring or attachment should be performed between the service satellite and the target.

Historically, adjusting trajectories of satellites required additional, expensive, and cumbersome equipment. For instance, robotic arms or electrostatic coupling may be used to grab the target. Further, a manned spacecraft may be used to grab and move the target, increasing risk of damage or failure.

In contrast, embodiments of the present disclosure provide advantages in that an independent service satellite may be used to anchor to the target to then service or move the target as desired. For instance, the service satellite may be a remotely controlled and therefore disposable vessel. As will be provided in more detail herein, various advantageous stem from a bolt assembly being able to anchor a service satellite to a target to then push or move the target to a desired location (e.g., space graveyard, deorbit, etc.).

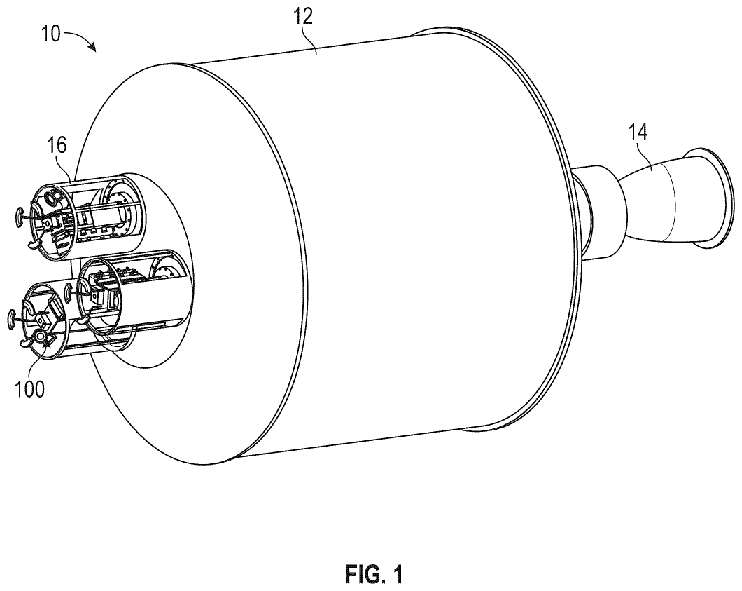

Referring now to the figures, FIG. 1 provides a perspective view of an exemplary service satellite according to exemplary embodiments of the present disclosure. For instance, service satellite 10 may be or include a spacecraft capable of independent propulsion and control. In some instances, service satellite 10 is an autonomous or remotely controlled spacecraft. Accordingly, service satellite 10 may be driven, piloted, or otherwise controlled remotely (e.g., by a remote pilot, astronaut, etc.). In still further embodiments, the spacecraft may include astronauts.

Service satellite 10 may thus include a main body 12. Main body 12 may have any suitable shape, such as cylindrical as shown. Service satellite 10 may include one or more propulsion systems 14. For instance, the one or more propulsion systems 14 may include engines, rockets, boosters, or the like. Accordingly, service satellite 10 may be capable of generating thrust to move independently or autonomously. It should be understood that the general construction and operation of spacecraft is known in the art, and a detailed description thereof will be omitted for the sake of brevity. It should appreciated that while one propulsion system is shown, this is for example purposes and the satellite 10 may have multiple propulsion systems.

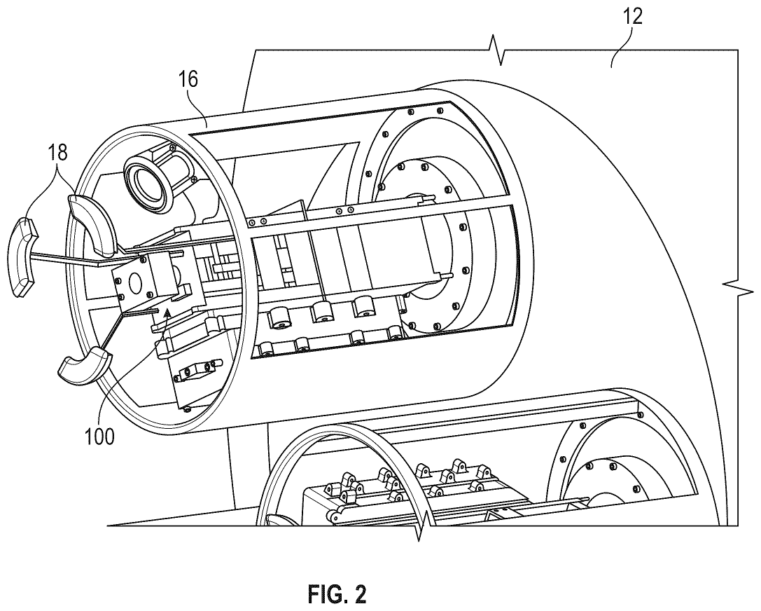

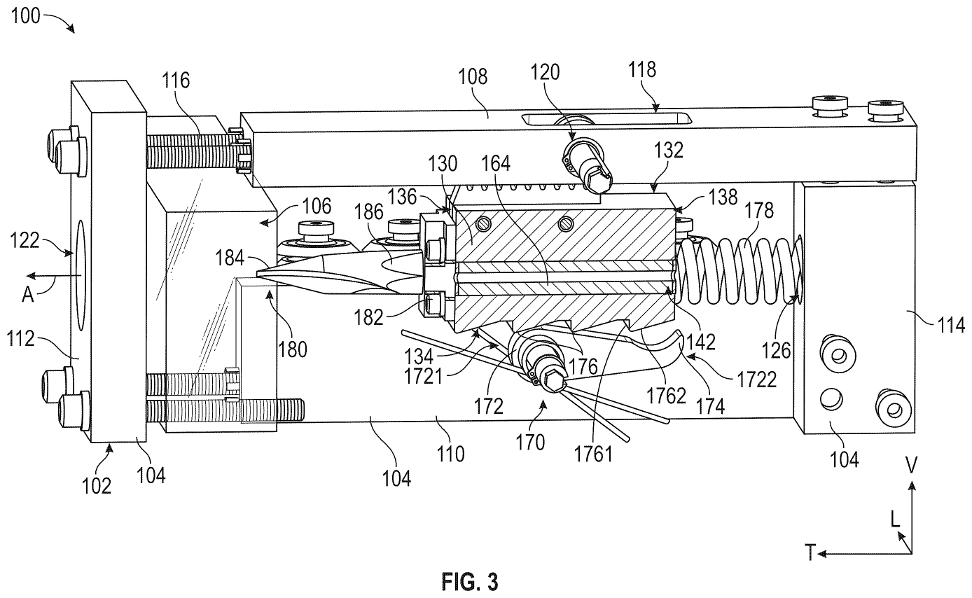

Service satellite 10 may include at least one bolt assembly 100. Bolt assembly 100 may be attached, coupled, or otherwise fixed to main body 12. For instance, as seen in FIGS. 1 and 2, bolt assembly 100 may be positioned at or along an outer surface or shell of main body 12. In some embodiments, bolt assembly 100 is provided at an opposite end of main body 12 from propulsion system 14. According to some instances, service satellite 10 includes one or more shell frames 16 protruding from main body 12. Bolt assembly 100 may be at least partially accommodated with a shell frame 16. For instance, shell frame 16 may be predominantly cylindrical and define an axial direction A. Bolt assembly 100 may be aligned within shell frame 16 such that a bolt head (explained below) may selectively extend from shell frame 16 along the axial direction A. For purposes of reference only, bolt assembly 100 may define a vertical direction V, a lateral direction L, and a transverse direction T (FIG. 3). It should be understood that the vertical direction V, lateral direction L, and transverse direction T may or may not correspond to the same with reference to Earth, and are merely used to describe and position elements and features relative to other elements and features.

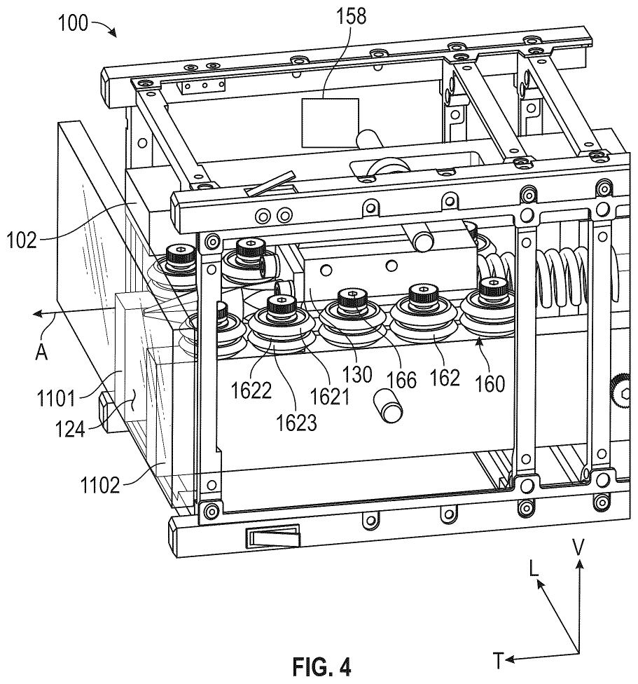

Referring now to FIGS. 3 through 5 with continuing reference to FIG. 1 and FIG. 2, bolt assembly 100 may include a carrier frame 102. Carrier frame 102 may include a plurality of frame members 104 that collectively form a receiving space 106. The plurality of frame members 104 may include a top piece 108, a bottom piece 110, a front piece 112, and a rear piece 114. Each of the plurality of frame members 104 may be coupled together via fasteners 116. For instance, one or more bolts, screws, etc. may couple front piece 112 to top piece 108 and bottom piece 110. Gaps may be formed between the plurality of frame members 104, according to some embodiments.

Top piece 108 may be or include a panel or block member. Top piece 108 may extend along the transverse direction T and the lateral direction L. Top piece may define a top face and a bottom face. A receiving aperture 118 may be defined therethrough from the top face to the bottom face (e.g., along the vertical direction V). Additionally or alternatively, a bearing hole 120 may be defined perpendicular to receiving aperture 118 (e.g., from a first side to a second side of top piece 108 along the lateral direction L). Bearing hole 120 may extend or be defined through receiving aperture 118. Bearing hole 120 may be configured to receive an axel (described in more detail below) therein.

Front piece 112 may be or include a panel or block member. Front piece 112 may extend along the vertical direction V and the lateral direction L. Front piece 112 may define a front face and a rear face. A penetration aperture 122 may be defined through front piece 112 from the front face to the rear face (e.g., along the transverse direction T). Penetration aperture 122 may be configured to allow a bolt head (described below) to selectively pass therethrough while restricting a bolt body (described below) from passing through. As mentioned, front piece 112 may be spaced apart from top piece 108 (e.g., along the transverse direction T). However, it should be understood that any suitable placement, positioning, and construction of front piece 112 and top piece 108 may be incorporated according to specific embodiments.

According to some embodiments, bottom piece 110 may include a first bottom piece 1101 and a second bottom piece 1102. First bottom piece 1101 may be spaced apart from second bottom piece 1102 (e.g. along the lateral direction L). For instance, first bottom piece 1101 may be or include a panel or block member. First bottom piece 1101 may extend along the transverse direction T and the vertical direction V. Similarly, second bottom piece 1102 may extend along the transverse direction T and the vertical direction V (e.g., parallel to first bottom piece 1101). Accordingly, a gap or channel 124 may be defined between first bottom piece 1101 and second bottom piece 1102.

Rear piece 114 may be or include a block. Rear piece 114 may be positioned or provided between first bottom piece 1101 and second bottom piece 1102 (e.g., within channel 124). Additionally or alternatively, rear piece 114 may contact the bottom face of top piece 108. Rear piece 114 may include a spring receiving groove 126 formed therein. Spring receiving groove 126 may be or include a blind hole formed into rear piece 114 along the transverse direction T. For instance, spring receiving groove 126 may face receiving space 106 of carrier frame 102.

Bolt assembly 100 may include a bolt body 130. Bolt body 130 may be movably (e.g., slidably) received within carrier frame 102. For instance, bolt body 130 may be configured to slide along a movement axis A. Movement axis A may be parallel with the transvers direction T. In detail, bolt body 130 may be movable (or slidable) amongst a plurality of positions. The plurality of positions may include a neutral (e.g., de-energized) position, an armed position (or one of a plurality of armed positions), and a released position, which will be explained in further detail below. Additionally or alternatively, bolt body 130 may have any suitable shape. According to some embodiments, bolt body 130 is predominantly shaped as an elongated cube (e.g., elongated along the transverse direction T).

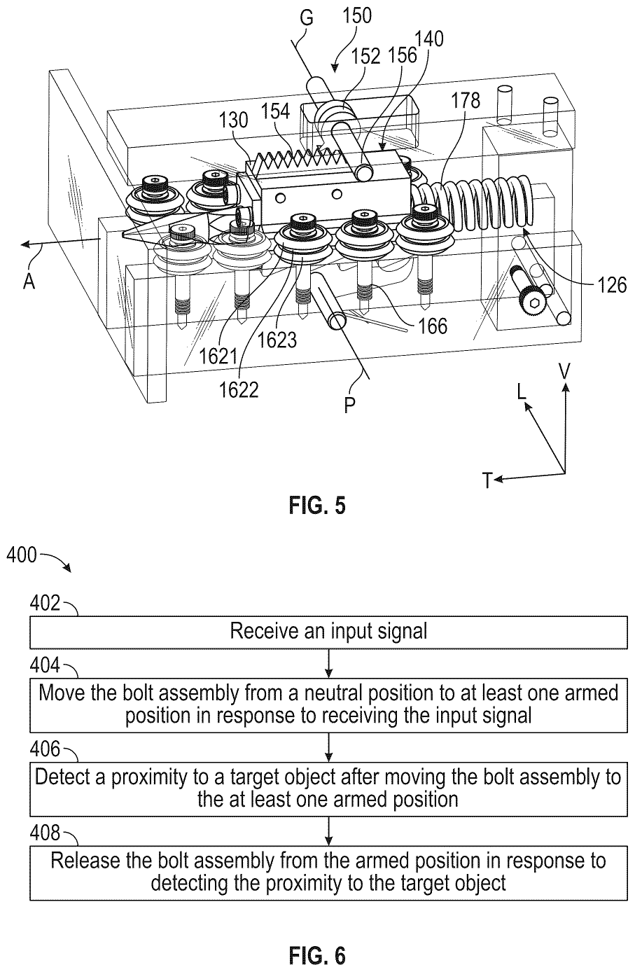

Bolt body 130 may be at least partially received within channel 124 (e.g., between first bottom piece 1101 and second bottom piece 1102). Accordingly, bolt body 130 may be configured to translate along movement axis A between first bottom piece 1101 and second bottom piece 1102. Bolt body may define a top face 132, a bottom face 134, a front face 136, a rear face 138, a first side face 140 (FIG. 5), and a second side face 142 opposite first side face 140. At least a portion of first side face 140 may be positioned adjacent to first bottom piece 1101 while at least a portion of second side face 142 may be positioned adjacent to second bottom piece 1102.

Bolt assembly 100 may include a gear assembly 150. Gear assembly 150 may be operably coupled with carrier frame 102 and bolt body 130. For instance, gear assembly 150 may be configured to slide, shift, translate, or otherwise move bolt body 130 with respect to carrier frame 102. Gear assembly 150 may this include a driving gear 152 and a driven gear 154. Driving gear 152 may be provided at carrier frame 102. In detail, driving gear 152 may be configured to rotate with respect to carrier frame 102. According to at least some embodiments, driving gear 152 and driven gear 154 are collectively a rack and pinion gear assembly or system. For instance, driving gear 152 may be a pinion gear and driven gear 154 may be a rack gear, as would be understood.

As mentioned above, top piece 108 may include bearing hole 120 defined therethrough (e.g., along the lateral direction L). An axel 156 may be accommodated within bearing hole 120 and configured to rotate therein. Driving gear 152 may be coupled to axel 156. Moreover, axel 156 may be configured to rotate about a gear axis G. For instance, driving gear 152 may be at least partially accommodated within receiving aperture 118. Thus, driving gear (or pinion) 152 may rotate collectively with axel 156 within receiving aperture 118. Additionally or alternatively, driving gear may include a plurality of gear teeth. In some instances, the plurality of gear teeth are provided over a predetermined circumferential length of driving gear 152.

Driven gear 154 may be provided on or along bolt body 130. For instance, driven gear 154 may be positioned at top face 132 of bolt body 130. In detail, driven gear may be operably coupled with driving gear 152. Driven gear 154 may be a linear gear. For instances, driven gear 154 may extend along bolt body 130 along movement axis A (e.g., along the transverse direction T). Thus, driven gear (or rack) 154 may be configured to move (e.g., slide, shift, translate) bolt body 130 in response to an input from driving gear 152. Driven gear 154 may include a plurality of teeth configured to mesh with the plurality of teeth on driving gear 152. Accordingly, as driving gear 152 rotates, driven gear translates along movement axis A.

Bolt assembly 100 may include a motor assembly 158. Motor assembly 158 may be operably coupled with driving gear 152. For instance, motor assembly 158 may be configured to provide a rotational input to axel 156. According to some embodiments, motor assembly 158 may include a belt, chain, or other power transmission device to transmit rotational power from a motor to axel 156. Further, motor assembly 158 may include a motor such as a stepper motor, a DC motor, a brushless motor, an electric motor, or the like. It should be understood that the type of motor may vary according to specific embodiments, and the disclosure is not limited to the examples provided herein.

Bolt assembly 100 may include a roller assembly 160. Roller assembly 160 may connect bolt body 130 with carrier frame 102. For instance, roller assembly may facilitate or assist in sliding bolt body 130 with respect to carrier frame 102. Roller assembly 160 may include a roller 162 and a rail 164. According to some embodiments, a plurality of rollers 162 are included. For instance, a first set of rollers 162 may be positioned at a first lateral side of bolt boy 130 and a second set of rollers 162 may be positioned at a second lateral side of bolt body 130. For the sake of brevity, a single roller 162 will be described herein with the understanding that the description may apply to two or more rollers.

Roller 162 may be configured to rotate about a roller axis. The roller axis may be parallel with the vertical direction V. For instance, roller 162 may be rotatably coupled to a roller axel 166. According to at least some embodiments, roller axel 166 is attached or connected at bottom piece 110. In detail, roller axel 166 may protrude from one of first bottom piece 1101 or second bottom piece 1102, or from each of first bottom piece 1101 and second bottom piece 1102 (e.g., along the vertical direction V). Roller 162 may include a first portion 1621 having a first diameter, a second portion 1622 having a second diameter, and a third portion 1623 having a third diameter. The second diameter may be less than each of the first diameter and the third diameter. Additionally or alternatively, the first diameter may be substantially the same as the third diameter. The second portion 1622 may be positioned between the first portion 1621 and the third portion 1623. Thus, an annular groove may be defined in roller 162 at the second portion.

In the instance where roller 162 is rotatably connected at bottom piece 110, rail 164 may be provided at bolt body 130. For instance, rail 164 may be formed as a part of bolt body 130. Rail 164 may extend along the movement axis A (e.g., along the transverse direction T). Additionally or alternatively, rail 164 may include a first rail positioned at the first lateral side of bolt body 130 and a second rail positioned at the second lateral side of bolt body 130. Rail 164 may selectively interact with roller 162. For instance, rail 164 may be selectively accepted at second portion 1622 of roller 162 (e.g., between first portion 1621 and third portion 1623). Advantageously, bolt body 130 may be supported along the lateral direction L and the vertical direction V while translating, moving, or sliding.

Bolt assembly 100 may include a ratchet system 170. Ratchet system 170 may operably connect bolt body 130 with carrier frame 102. For instance, ratchet system 170 may be configured to selectively restrain bolt body 130 at one of a plurality of positioned with respect to carrier frame. As will be explained in more detail below, bolt body 130 may be selectively biased along the movement axis A. As such, ratchet system may hold bolt body 130 in a position and release bolt body 130 according to an input.

Ratchet system 170 may include a ratchet pawl 172. Ratchet pawl 172 may be operably coupled to carrier frame 102. Ratchet pawl 172 may be configured to be rotatable with respect to carrier frame 102. In some instances, ratchet pawl 172 is coupled at bottom piece 110. In detail, ratchet pawl 172 may be positioned between first bottom piece 1101 and second bottom piece 1102 (e.g., within channel 124). Ratchet pawl 172 may be rotatable about a pawl axis P. The pawl axis P may be parallel with the gear axis G (e.g., along the lateral direction L).

Ratchet pawl 172 may include a fixed end 1721 and a free end 1722. Fixed end 1721 may be connected at the pawl axis P. Accordingly, free end 1722 may be positioned apart from fixed end 1721. Free end 1722 may include a hook portion 174. As best seen in FIG. 3, hook portion 174 may be at least partially concave upward along the vertical direction V. Thus, as ratchet pawl 172 rotates about pawl axis P, hook portion 174 may selectively contact bottom face 134 of bolt body 130. Additionally or alternatively, ratchet pawl 172 may be operably coupled with a motor to selectively rotate ratchet pawl 172. According to some embodiments, ratchet pawl 172 is operably coupled with motor assembly 158. However, it should be understood that one or more additional motors or motor assemblies may be incorporated according to specific embodiments.

Ratchet system 170 may include a plurality of ratchet teeth 176. Referring again to FIG. 3, ratchet teeth 176 may be formed into bolt body 130. For instance, ratchet teeth 176 may be formed into or along bottom face 134 of bolt body 130. Hereinafter, a single ratchet tooth 176 will be described with the understanding that the description may apply to each ratchet tooth 176. Ratchet tooth 176 may be predominantly saw tooth shaped. For instance, ratchet tooth 176 may include a catch surface 1761 and a run surface 1762. Catch surface 1761 may extend predominantly along the vertical direction V. Thus, as ratchet pawl 172 is rotated such that hook portion 174 contacts bottom face 134, ratchet pawl 172 may be restrained along the movement axis A by catch surface 1761. Run surface 1762 may extend at an acute angle with respect to the transverse direction T. For instance, run surface 1762 may extend from a distal end of catch surface 1761 to bottom face 134 of bolt body 130. Accordingly, ratchet tooth 176 may have a predominantly wedge shape.

As noted, a plurality of ratchet teeth 176 may be included. The plurality of ratchet teeth 176 may be provided sequentially along the movement axis A (e.g., along the transverse direction T). As would be understood, bolt body 130 may be selectively restrained at one of a plurality of positions along the movement axis A.

Bolt assembly 100 may include a release mechanism 178. Release mechanism 178 may be operably coupled with bolt body 130 and carrier frame 102. For instance, release mechanism 178 may be positioned between bolt body 130 and carrier frame 102. In some embodiments, release mechanism is coupled or fixed to carrier frame 102. Release mechanism may selectively bias bolt body 130 along the movement axis A. For instance, release mechanism 178 may bias bolt body 130 toward front piece 112.

Release mechanism 178 may include an elastic or biasing member. According to some embodiments, release mechanism 178 includes a compression spring. However, release mechanism 178 may be any suitable element capable of providing a biasing force, such as a compressible rubber, a deflectable plastic, a malleable compound, or the like. Release mechanism 178 may be at least partially accommodated within spring receiving groove 126 of rear piece 114. Accordingly, release mechanism 178 may contact rear face 138 of bolt body 130. As bolt body 130 is moved by gear assembly 150 (e.g., rearward along the movement axis A toward rear piece 114), ratchet pawl 172 may catch at one of the plurality of ratchet teeth 176 to be then temporarily held in place. Bolt body 130 may be selectively held at one of the plurality of armed positions (e.g., with release mechanism 178 energized). Thus, release mechanism 178 may store a predetermined amount of potential energy when bolt body is in an armed position. It should be appreciated that in some embodiments, the amount of energy stored in the release mechanism 178 may be continuously varied between a first energy level and a second (or maximum) energy level. In other embodiments the amount of energy stored in the release mechanism may be incrementally increased from a first energy level to a second energy level.

In response to an input signal, ratchet pawl 172 may be rotated away from bolt body 130 (e.g., to disengage from ratchet tooth 176). Once unencumbered, release mechanism 178 may move (e.g., forcibly move) bolt body 130 from the armed position to the released position. As release mechanism 178 is released, bolt body 130 may move toward front piece 112. An amount of force imparted to bolt body 130 via release mechanism 178 may be determined according to the armed position (e.g., of the plurality of armed positions).

Bolt assembly 100 may include a bolt head 180. Bolt head 180 may be fixed to bolt body 130. For instance, bolt head 180 may be attached to bolt body 130 via one or more fasteners 182. The one or more fasteners 182 may include bolts, rivets, screws, adhesives, hooks, clips, or the like. In some instances, bolt head 180 may be fixed to bolt body 130 via one or more explosive bolts or release bolts, such that bolt head 180 may be selectively released from bolt body 130 by discharging the explosive bolts. Bolt head 180 may be attached at front face 136 of bolt body 130. Accordingly, bolt head 180 may face or be directed toward front piece 112 of carrier frame 102.

Bolt head 180 may include at least one spike (e.g., prong, spine, arm, etc.) 184. Spike 184 may protrude along the movement axis A (e.g., along the transverse direction T). For instance, spike 184 may point toward front piece 112. Spike 184 may be configured to taper toward a distal end thereof (e.g., away from bolt body 130). As mentioned above, bolt head 180 (e.g., spike 184) may selectively penetrate front piece 112 (e.g., penetration aperture 122). For example, when bolt body 130 is moved to the released position, spike 184 may be positioned through penetration aperture 122 and disposed outside of carrier frame 102. Advantageously, spike 184 may pierce a target by moving forcibly through penetration aperture 122, thus coupling service satellite 10 to the target (e.g., a target satellite, space-craft, space debris, etc.).

Spike 184 may include a barb 186. For instance, spike 184 may include a plurality of barbs 186 protruding or extending therefrom. In detail, barb 186 may extend at least partially toward bolt body 130 from spike 184. Barb 186 may be configured to catch a portion of the target to which spike 184 is pierced and attached to prevent or inhibit the removal of the spike 184 from the target. In some instances, the plurality of barbs 186 are positioned sequentially over a length of spike 184 along the transverse direction T. Additionally or alternatively, the plurality of barbs 186 may be spaced around spike 184 along a circumferential direction.

Spike 184 may have a predetermined length along the transverse direction T (e.g., along the movement axis A). For instance, spike 184 may have a length of between about 0.5 inches and about 3 inches. Additionally or alternatively, spike 184 (and bolt head 180) may be made from a hardened material. For example, spike 184 may be formed from a hardened stainless steel. However, it should be understood that spike 184 and bolt head 180 may have any suitable length and may be formed from any suitable material, and the disclosure is not limited to the examples provided herein. Further still, spike 184 may include one or more grooves (e.g., helical grooves) formed therein.

According to at least some embodiments, bolt body 130 and bolt head 180 may collectively be referred to as a spike assembly. The spike assembly may thus be configured to at least partially eject from carrier frame 102. Bolt head 180 (e.g., spike 184) may be configured to pierce a piece or section of a satellite or other space equipment. Thus, spike 184 may be configured to anchor to materials commonly used in satellite equipment, such as aluminum, carbon fiber, or the like. Additionally or alternatively, spike 184 may be configured to interact with (e.g., catch) certain material shapes, such as honeycomb shapes. However, the spike assembly may be used or deployed in any suitable fashion to pierce, puncture, penetrate, or anchor to any suitable element or object, and the disclosure is not limited to the examples provided herein.

Returning briefly to FIG. 2, service satellite 10 may include a sensor 18. In detail, one or more sensors 18 may be provided at shell frame 16 of satellite 10. The one or more sensors 18 may extend from main body 12 (e.g., from within shell frame 16). The one or more sensors 18 may be positioned adjacent to bolt assembly 100. For instance, the one or more sensors 18 may be spaced equidistant about bolt assembly 100. Additionally or alternatively, the one or more sensors 18 may be positioned or disposed further from main body 14 than front piece 112 of carrier frame 102 of bolt assembly 100. According to at least some embodiments, at least three sensors 18 are provided. Hereinafter, a single sensor 18 will be described with the understanding that the description may apply to each of a plurality of sensors 18.

Sensor 18 may be configured to monitor, sense, or otherwise determine a location of satellite 10 with respect to a target (e.g., target satellite, space debris, etc.). For instance, sensor 18 may be a proximity sensor or switch. Sensor 18 may be a contact or haptic sensor configured to emit a signal (e.g., to a controller) when sensor 18 comes into contact with the target. In additional or alternative embodiments, sensor 18 may include one or more image capture devices (e.g., cameras), infrared sensors, contact switches, or the like. Advantageously, sensor 18 may determine when service satellite 10 is in a proper position to successfully release bolt body 130 to deploy bolt head 180.

Now that the general description of a service satellite (e.g., service satellite 10) and bolt assembly (e.g., bolt assembly 100) have been provided, a method 400 of operating a bolt assembly will be described. Method 400 may be applied to bolt assembly 100 or any other suitable mechanism or assembly capable of selectively releasing a catch (e.g., spike, hook, magnet, etc.). It should be understood that the method steps described herein may be applied in any suitable order, and the order provided is by way of example only. Further, steps may be added or removed according to specific embodiments while remaining within the scope of the disclosure.

Method 400 may be applied when a service satellite (e.g., service satellite 10) is deployed to engage and anchor with a target satellite (or any suitable target). With reference to FIG. 6, at 402, method 400 may include receiving an input signal. The input signal may be associated with a command to anchor to a target or target satellite. The input signal may be received from a remote device (e.g., such as a remote shuttle or space craft, a terrestrial center, a command center, etc.). For instance, the service satellite may be deployed before the signal is received. However, in some instances, the signal may be received while the service satellite is still stationary, docked, or otherwise not deployed.

Upon receiving the signal, at 404, method 400 may include moving a bolt assembly to at least one armed position. For instance, in response to receiving the input signal, a motor assembly (e.g., motor assembly 158) may be initiated to move a bolt body (e.g., bolt body 130) of the bolt assembly into one of a plurality of armed positions. As described above, each armed position may be associated with a specific ratchet tooth of a ratchet system coupled between the bolt body and a frame (e.g., carrier frame 102). The specific armed position may be based on one or more characteristics of the target. For instance, a plunge depth of a spike (e.g., spike 184), a thickness of a target panel to be pierced, a material composition of the target, a distance of the target, or the like may be incorporated in determining the appropriate armed position.

At 406, method 400 may include detecting a proximity to a target object after moving the bolt assembly to the at least one armed position. As mentioned above, the satellite may include one or more sensors (e.g., sensors 18). The sensors may detect or sense that the satellite is in contact with or in proximity to a target and send a corresponding signal to, for instance, a controller. The controller may be provided on board the satellite, on board a bolt assembly (e.g., bolt assembly 100), or may be a remote controller (e.g., not present on the satellite). Additionally or alternatively, the proximity to the target may be determined via one or more cameras or other image capture devices (e.g., still cameras, video cameras, etc.).

At 408, method 400 may include releasing the bolt assembly from the armed position in response to detecting the proximity to the target object. As mentioned above, the bolt assembly may include a bolt (e.g., bolt body 130 and bolt head 180 collectively) configured to be moved (e.g., fired) from the armed position. Thus, upon confirming the proximity to (or contact with) the target object, the bolt may be released. In some instances, a ratchet pawl (e.g., ratchet pawl 172) may be rotated, such as by a motor. The bolt may be energized in the armed position by a release mechanism (e.g., release mechanism 178). Thus, the bolt may be fired, ejected, or otherwise moved to the released position. In the released position, the bolt may project outside of the carrier frame and the shell frame to pierce the target object and thus anchor the service satellite to the target object.

The detailed description explains embodiments of the disclosure, together with advantages and features, by way of example with reference to the drawings.

The term “about” is intended to include the degree of error associated with measurement of the particular quantity based upon the equipment available at the time of filing the application.

It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

What is claimed is:

1. A service satellite comprising:
a main body; and
a bolt assembly coupled to the main body, the bolt assembly comprising:
a carrier frame;
a bolt body movably accommodated within the carrier frame, the bolt body being movable along a movement axis amongst a neutral position, at least one armed position, and a released position;
a bolt head protruding from the bolt body along the movement axis, wherein the bolt head protrudes through the carrier frame when the bolt body is in the released position; and
a release mechanism operably coupled with the bolt body, the release mechanism configured to selectively move the bolt body from the at least one armed position to the released position in response to an input signal.

2. The service satellite of claim 1, wherein the release mechanism comprises a compression spring.

3. The service satellite of claim 1, wherein the bolt assembly further comprises:
a gear assembly operably coupled with each of the carrier frame and the bolt body, the gear assembly comprising:
a driving gear provided at the carrier frame and configured to rotate; and
a driven gear provided at the bolt body, the driven gear configured to move the bolt body in response to an input from the driving gear.

4. The service satellite of claim 3, wherein the driven gear is a linear gear extending along the bolt body along the movement axis.

5. The service satellite of claim 3, wherein the bolt assembly further comprises:
a motor assembly operably coupled with the driving gear, the motor assembly configured to selectively rotate the driving gear.

6. The service satellite of claim 1, wherein the bolt assembly further comprises:
at least one roller attached to one of the bolt body or the carrier frame; and
at least one rail provided at one of the bolt body or the carrier frame, wherein the at least one roller is configured to roll along the at least one rail as the bolt body moves within the carrier frame.

7. The service satellite of claim 6, wherein the at least one roller comprises a plurality of rollers positioned at each side of the carrier frame, the plurality of rollers being rotationally supported at the carrier frame, and wherein the at least one rail comprises a first rail formed into a first side of the bolt body and a second rail formed into a second side of the bolt body, each of the first rail and the second rail extending along the movement axis.

8. The service satellite of claim 1, wherein the bolt assembly further comprises a ratchet system operably connecting the bolt body with the carrier frame, the ratchet system comprising:
a ratchet pawl attached to the carrier frame, the ratchet pawl being rotatable about a ratchet axis; and
a plurality of ratchet teeth formed into the bolt body, wherein the bolt body is selectively restrained along the movement axis via the ratchet system.

9. The service satellite of claim 1, wherein the bolt head comprises a plurality of barbs protruding therefrom at least partially toward the bolt body.

10. The service satellite of claim 1, wherein the bolt head is attached to the bolt body via a plurality of fasteners.

11. The service satellite of claim 1, further comprising:
at least one sensor extending from the main body adjacent the bolt assembly.

12. The service satellite of claim 11, wherein the at least one sensor comprises three sensors spaced equidistant about the bolt assembly.

13. A bolt assembly for use on a spacecraft, the bolt assembly comprising:
a carrier frame;
a bolt body movably accommodated within the carrier frame, the bolt body being movable along a movement axis amongst a neutral position, at least one armed position, and a released position;
a bolt head protruding from the bolt body along the movement axis, wherein the bolt head protrudes through the carrier frame when the bolt body is in the released position; and
a release mechanism operably coupled with the bolt body, the release mechanism configured to selectively move the bolt body from the at least one armed position to the released position in response to an input signal.

14. The bolt assembly of claim 13, wherein the release mechanism comprises a compression spring.

15. The bolt assembly of claim 13, further comprising:
a gear assembly operably coupled with each of the carrier frame and the bolt body, the gear assembly comprising:
a driving gear provided at the carrier frame and configured to rotate; and
a driven gear provided at the bolt body, the driven gear configured to move the bolt body in response to an input from the driving gear.

16. The bolt assembly of claim 15, further comprising:
a motor assembly operably coupled with the driving gear, the motor assembly configured to selectively rotate the driving gear.

17. The bolt assembly of claim 13, further comprising:
at least one roller attached to one of the bolt body or the carrier frame; and
at least one rail provided at one of the bolt body or the carrier frame, wherein the at least one roller is configured to roll along the at least one rail as the bolt body moves within the carrier frame.

18. The bolt assembly of claim 13, further comprising a ratchet system operably connecting the bolt body with the carrier frame, the ratchet system comprising:
a ratchet pawl attached to the carrier frame, the ratchet pawl being rotatable about a ratchet axis; and
a plurality of ratchet teeth formed into the bolt body, wherein the bolt body is selectively restrained along the movement axis via the ratchet system.

19. The bolt assembly of claim 13, wherein the bolt head comprises a plurality of barbs protruding therefrom at least partially toward the bolt body.

20. A method of operating a bolt assembly, the method comprising:
receiving an input signal;
moving the bolt assembly from a neutral position to at least one armed position in response to receiving the input signal;
detecting a proximity to a target object after moving the bolt assembly to the at least one armed position; and
releasing the bolt assembly from the armed position in response to detecting the proximity to the target object.
